(19) United States
(12) Patent Application Publication
(10) Pub. No.: US 2016/0046368 A1
(43) Pub. Date: Feb. 18, 2016

(54) SYSTEM FOR OPERATING HELICOPTER BLADES WITH COMPRESSED AIR

(71) Applicant: AIRI RE SRL UNIPERSONALE, Roma (RM) (IT)

(72) Inventors: Riccardo Aichner, Verona (IT); Pasquale De Rosa, Formello (IT)

(73) Assignee: AIRI RE SRL UNIPERSONALE, Roma (IT)

(21) Appl. No.: 14/780,405

(22) PCT Filed: Mar. 24, 2014
(86) PCT No.: PCT/IB14/00410

§ 371 Date: Sep. 25, 2015

(30) Foreign Application Priority Data
Mar. 25, 2013 (IT) CZ2013A000005
Mar. 24, 2014 (IT) CZ2014A000005

(51) Int. Cl. B64C 27/12; B64C 27/48

(52) U.S. Cl. CPC B64C 27/12; B64C 27/48

(57) ABSTRACT

A system for operating helicopter blades with compressed air includes at least a first machine having an engine and configured for generating mechanical power to lift the helicopter; at least a second machine having a compressor and configured for generating compressed air for operating the hollow blades, the first machine being coupled with the second machine; and a rotor having a hollow shaft and an oscillating hollow head supporting the blades. The hollow shaft of the rotor internally including a conduit connecting the hollow shaft of the rotor to the hollow head. The oscillating hollow head is an elastic head and comprises an elastomeric flexible and deformable channel connecting the conduit with the blades and having a shape as at least one “V” and a number of branches equal to the number of the blades, the branches being able to guide the compressed air towards nozzles of the blades.

### BACKGROUND

1. Technical Field

The present invention relates to a system for operating helicopter blades with compressed air.

In particular, the present invention relates to a system for operating the helicopter blades with compressed air, of the type comprising a compressor for providing compressed air to the helicopter blades.

2. Description of the Related Art

As is known, helicopters are equipped with a rotor comprising a rotating shaft (called also “mast”) and blades that generate the necessary lift to sustain flight. The rotor has adjustable speed and inclination and is driven by a motor. The rotor is operated on a shaft in free rotation or rotated by motors. At the top of the shaft are generally attached two or more blades.

The rotor, due to its complexity, is a fundamental system of the rotorcraft. The blades of a rotorcraft are long and narrow airfoils with a high aspect ratio and a shape that minimizes the resistance caused by the extremities vortices.

Generally, a helicopter can have two rotors, the main and the secondary. The main rotor has two types of rotation: —the rotation around a vertical axis, in which the blades rotate at high speed developing a higher vertical lift opposite to the weight force of the helicopter; —the inclined rotation, in which the fast rotation of the blades develops a lift having a vertical component that supports the weight of the helicopter and a horizontal lift. In general, the rotor tilts in the advancement direction. The secondary rotor is placed in the helicopter tail to develop a compensation lift which keeps the tail motionless, since the tail, reacting to the rotation of the rotor, would tend to turn in the opposite direction.

Moreover, there are some helicopters in which the tail rotor was replaced by a fan located at the root of the tail boom cable into which pressurized air is channeled from the fan and which is laterally expelled at the end of the tail boom by creating the desired yaw force.

The helicopter is also equipped with motors that move the rotors, causing the blades to rotate.

There are also, in the prior art, solutions in which the mechanical power is not transferred directly to the blades, but there is a turbine engine that generates a compressed fluid. In these solutions, in fact, the propulsion of the blades is achieved by the ejection of hot gas generated in the engine: substantially fluid is taken from the compressor of the engine having, however, as a consequence the change of the thermodynamic cycle of the engine with a drastic reduction of the global efficiency. Then the fluid is transferred from the motor to the blades by means of fixed tubes provided outside of the mechanical structure of the rotor of the helicopter, and then it is inserted in a box composed of two parts: a first part fixed to the structure of the helicopter and a second part rotating with the rotor head.

However, these solutions have the problem of not making the box with the hot fluid at a pressure of several atmospheres, about 5, actually sealed. These tubes, that constitute the fluid pipeline, in fact, are subject to the relative rotation in the rotor head area. Moreover, the rotor head is subject to the rotor vibrations, and therefore, is not air-proof and has a reduced seal warranty in time, being, therefore, prone to leakage with further decrease of the overall performance.

Therefore, the state of the art have problems related to the global efficiency and to the pressure loss of the fluid. In particular, in reference to the first problem, an aircraft can fly efficiently with a design load equal to the sum of the fuel weight and of the weight of the objects to be transported called payload. The known solutions, having very low efficiency, do not allow to carry substantial amounts of fuel, with the result of flying with a certain endurance and little payload or payload and with very low endurance. The second problem remains in the ends jet system: the fluid that must arrive at the end of the blades, but between the fixed part and the rotating part, it is under pressure and the pressure loss causes the additional reduction of efficiency.

A solution to this problem is proposed in the PCT application WO 96/25328 published on Aug. 22, 1996, in the name of Milot Michel. This patent application discloses a system for operating helicopter blades with compressed air, comprising an engine for generating mechanical power necessary to the helicopter lift; a compressor for generating the compressed air for operating the hollow blades, coupling means for coupling the engine with the compressor and coupling means for coupling the compressor with the blades comprising a hollow shaft of the rotor and an oscillating hollow head of the rotor supporting the blades. The hollow shaft of the rotor internally comprises a conduit connecting the hollow shaft of the rotor to the oscillating hollow head.

Even if advantageous under many aspects, this solution doesn't solve the problem of defining an efficient way for connecting the jet propelled blades of an oscillating rotor to the power source.

### BRIEF SUMMARY

A purpose of the present invention is to provide a system for operating the helicopter blades with compressed air so as to overcome the limitations which still affect the systems and the helicopters previously described with reference to the known technique.

According to the present invention, a system for operating the helicopter blades with compressed air is provided, as defined in claim 1.

### BRIEF DESCRIPTION OF THE SEVERAL VIEWS OF THE DRAWINGS

For a better understanding of the present invention a preferred embodiment is now described, purely as non-limiting example, with reference to the accompanying drawings, in which:

FIG. 1 shows a schematic side view of a helicopter comprising a system for operating the helicopter blades with compressed air, according to the invention;

FIGS. 2A-2B show schematic views of a first and of a second embodiment of a system for operating the helicopter blades with compressed air, according to the invention;

FIG. 3 shows a first schematic view of the rotor head, comprising an elastic and flexible elastomeric channel also with a plenum purpose and an oscillating part, of a helicopter comprising the system for operating the helicopter blades with compressed air, according to the invention;

FIG. 4 shows a first schematic view of rotor head comprising an elastomeric channel also with a plenum purpose and an elastic part of a helicopter comprising the system for operating the helicopter blades with compressed air, according to the invention;

FIG. 5 shows a second more detailed schematic view of the rotor of FIG. 3 and the route taken by the compressed air across the head to the blades of a helicopter having two blades and comprising the system for operating the helicopter blades with compressed air, according to the invention;

FIG. 6 shows a second more detailed schematic view of the FIG. 4 and the path taken by the compressed air across the head to the blades of a helicopter having two or more than two blades and comprising the system for operating the helicopter blades with compressed air, according to the invention;

FIG. 7a shows a schematic top view of the rotor head of the two-bladed helicopter comprising the system for operating the helicopter blades with compressed air, according to the invention;

FIGS. 7b-7c are schematic top views of the rotor head, respectively, of a three-bladed helicopter and four-bladed helicopter comprising the system for operating the helicopter blades with compressed air, according to the invention.

### DETAILED DESCRIPTION

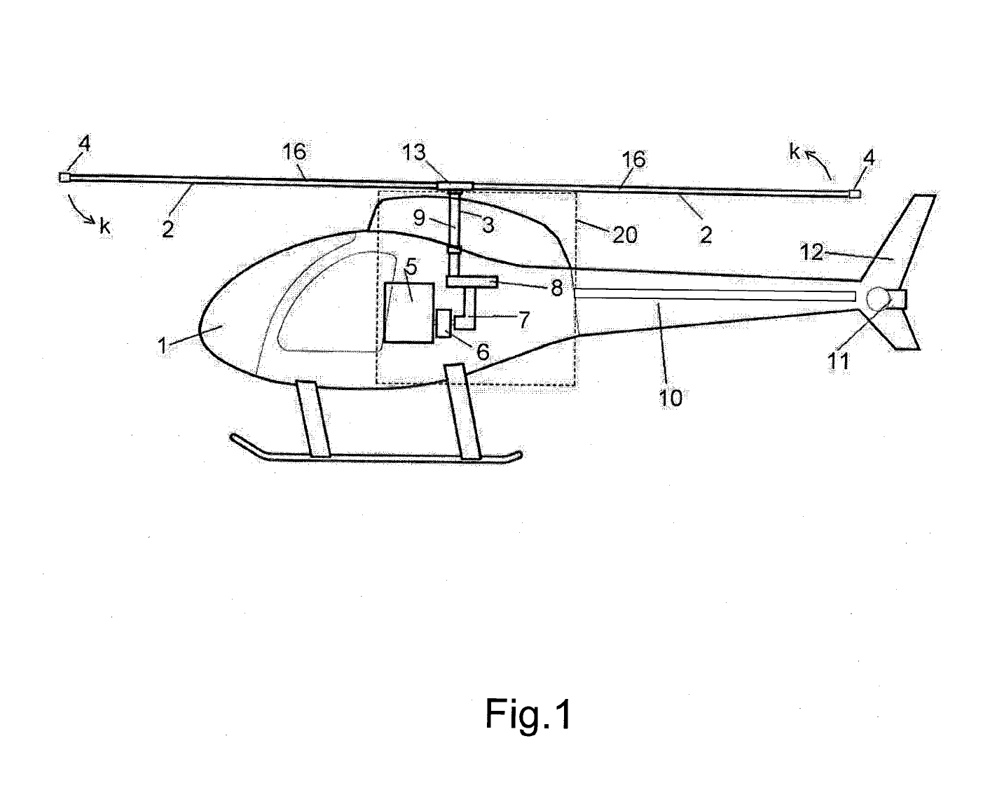

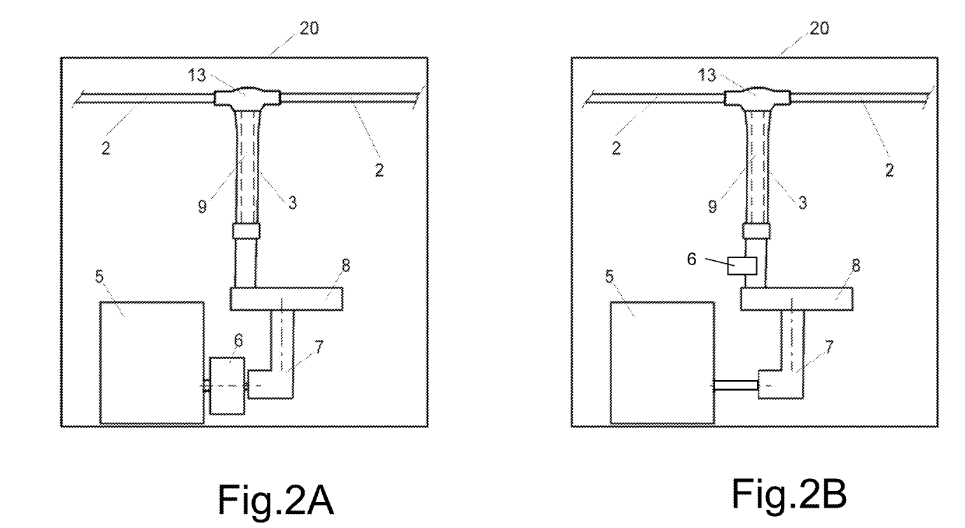

With reference to these figures, and in particular to FIGS. 1 and 2A-2B, a system 20 for operating the helicopter blades with compressed air is shown, according to the invention. In details, the helicopter 1 comprises a rotor 3, blades 2 with nozzles 4 for the air to escape and a system 20 for operating the helicopter blades with compressed air, comprising a first machine dedicated to the generation of mechanical power, a second machine configured to generate a fluid mass of gas, for example compressed air, at a low temperature (about 50° C.) and a pressure of approximately 2,5 atmospheres for operating the blades 2, and coupling elements of the first machine with the second machine and of the second machine with blades 2.

More precisely, the first machine comprises a motor 5 and the second machine comprises a compressor 8.

Advantageously according to the invention, the motor 5 can be any engine that generates mechanical power.

Advantageously according to the invention, the compressed air is generated by the compressor 8 which uses the mechanical power of the engine 5.

The coupling elements that couple the first machine with the second machine may comprise a release element 6, for example mechanical upstream of the compressor, as shown in FIG. 2A, or fluid downstream of the compressor, as shown in FIG. 2B, for the free rotation of the rotor 3, and which acts on the motor 5, and a gearbox 7 at the output element 6, configured for activating the compressor 8. The coupling elements of the second machine with the blades 2 comprise the hollow shaft, or mast, of the rotor 3 comprising internally a conduit 9, and an oscillating elastic hollow head 13 of the rotor 3.

According to an aspect of the invention, the release element 6 is a clutch or a similar element.

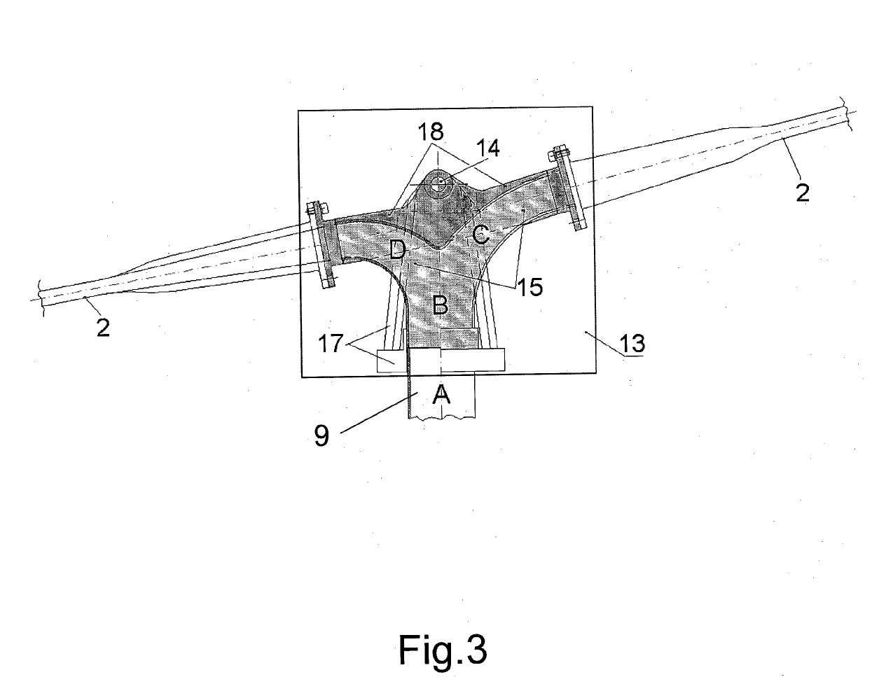

FIG. 3 shows, in details, the elastic and oscillating hollow rotor head 13 through which compressed air can be transported from the hollow shaft of the rotor 3 to the hollow blades 2. In particular, a flexible and deformable elastomeric channel 15 is comprised between the conduit 9 of the hollow shaft of the rotor 3 and the hollow blades 2.

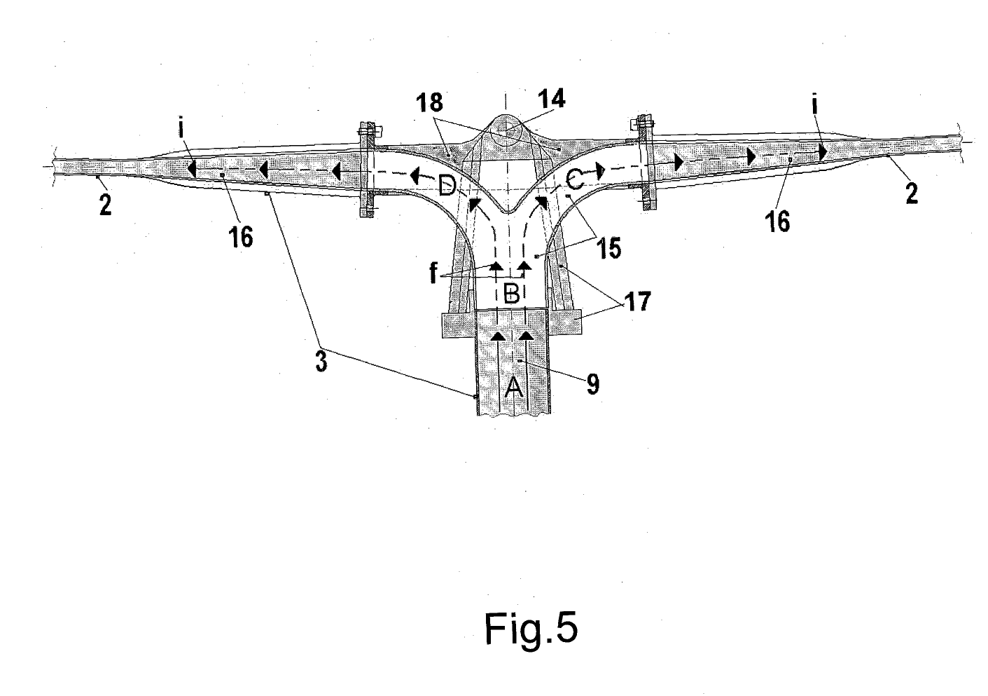

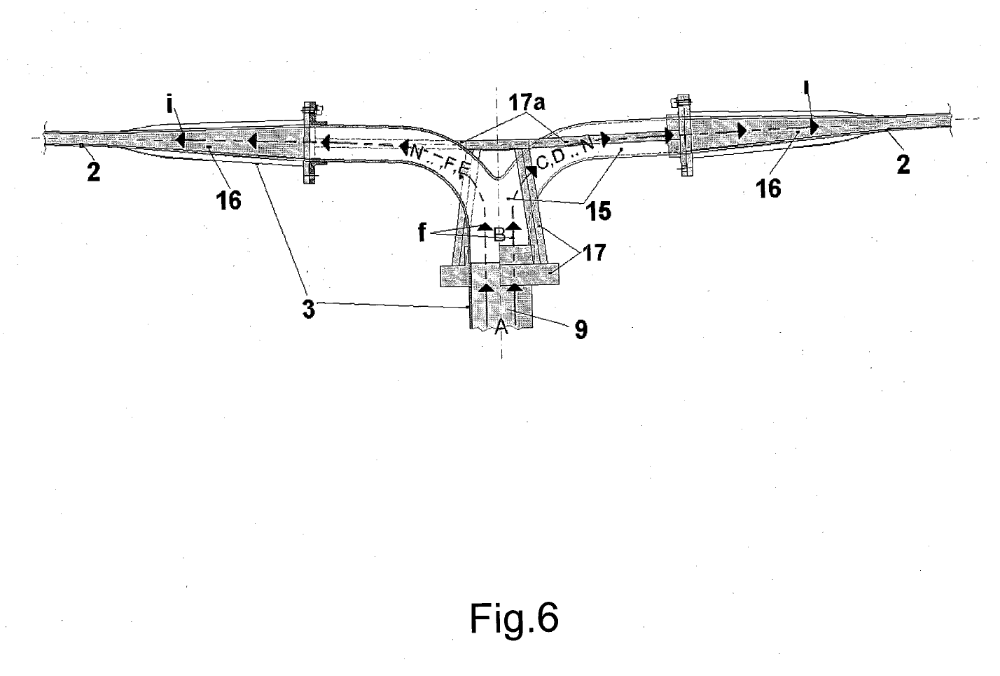

Advantageously according to the invention, the elastomeric channel 15 is a flexible elastomeric tube having a configuration like a multiple “V” and developing, in the terminal part of the “V”, with a number of branches equal to the number of blades present in the helicopter. The function of the elastomeric channel 15 is to transport the compressed air to the blades 2. Therefore, in the case of two-bladed helicopter, as shown in FIG. 5, the compressed air follows a path formed by a portion A inside the conduit 9, B inside the elastomeric channel 15, then splitting in branches C and D channeling the air towards the blades 2. Instead, in the case of helicopter having more than two blades, as shown in FIG. 6, the compressed air follows a path formed by a portion A inside the conduit 9, B inside the elastomeric channel 15, then splitting in the branches C, D or E . . . N , F . . . N channeling the air towards the blades 2.

Advantageously according to the invention, as shown in FIGS. 3 and 5, the elastic/oscillating hollow head 13 of the rotor is supported by a structure 17 fixed on the hollow shaft of the rotor 3 that, through a hinge 14, called flapping hinge, supports oscillating blades 2, only in the case of a helicopter with two blades and flapping hinge. The structure 17 connects, in the case of the two-bladed solution with the hinge of FIG. 3, the conduit 9 to the blades 2 through an oscillating part 18 of the rotor head 13 oscillating around the hinge 14.

According to an aspect of the invention, the structure 17 is metallic.

According to another aspect of the invention, the structure 17 is made of structural materials, for example metals or composites or others.

FIG. 5 shows schematically that the compressed air supplied from the compressor 8 is channeled in the conduit 9, in the direction indicated by the arrow f and is subdivided, inside the hollow oscillating head 13, as indicated by dashed arrows f and i, to flow in the conduits 16 of the blades 2 until reaching the nozzle 4, from which the flow of air escapes, as indicated by arrows k in FIG. 1.

In FIG. 6 the rotor head 13 is shown in the case of a helicopter having two or more than two blades, for example N blades. The rotor head 13 comprises a flexible horizontal structure 17a, connected to the structure 17, which allows the oscillation of the rotor head 13 and the elastomeric channel 15 transferring the flow of compressed air to the blades 2, through which the conduit 9 is connected in a perfectly sealed way to the rotor head 13, in such a way that the compressed air will channel into arms 19a, 19b, 19c, . . . 19N extending on the ramifications of the multiple “V” shaped flexible tube of the channel 15, in a perfectly sealed way towards the blades of the helicopter 2.

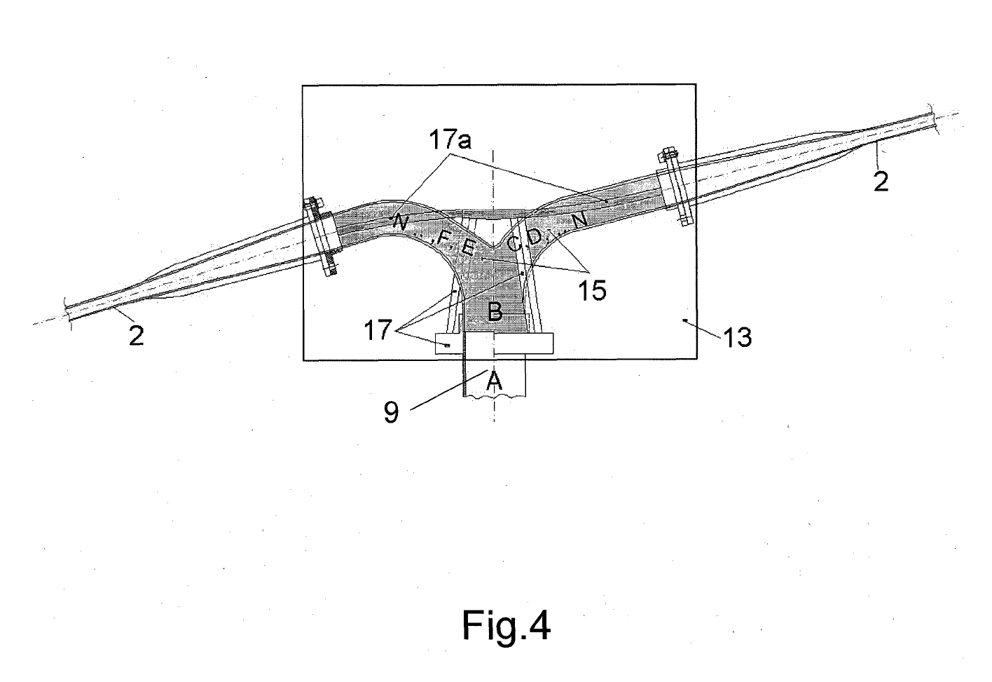

Advantageously according to the invention, the structure 17 is configured for absorbing the forces acting on the elastic/oscillating hollow head 13 shown in FIGS. 3 and 5 and the elastic/flexible hollow head 13 shown in FIGS. 4 and 6.

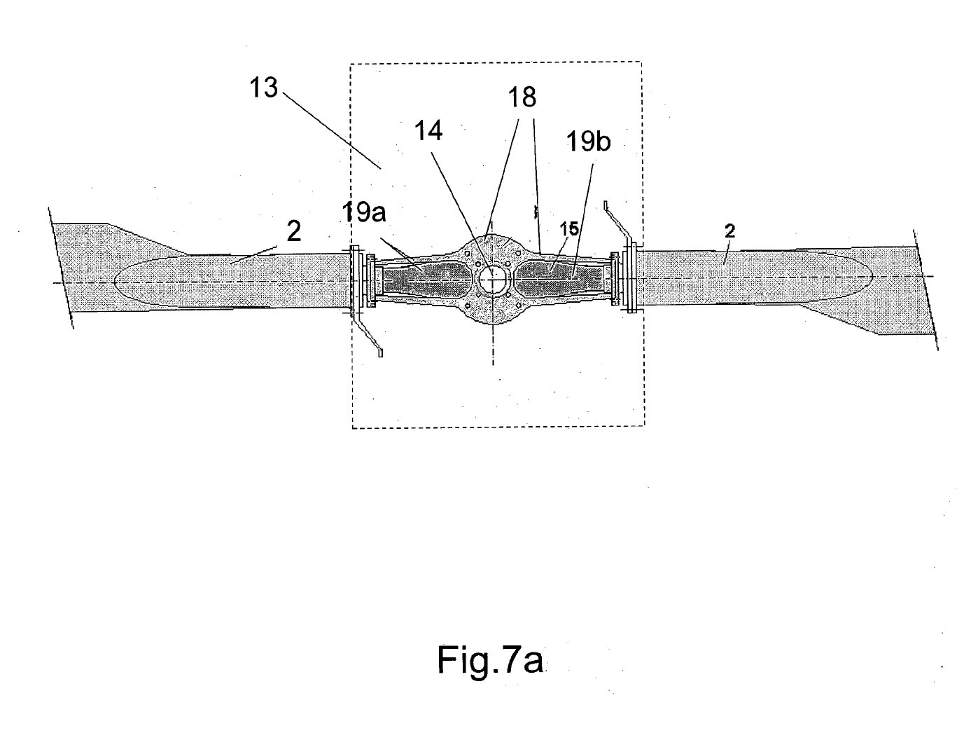

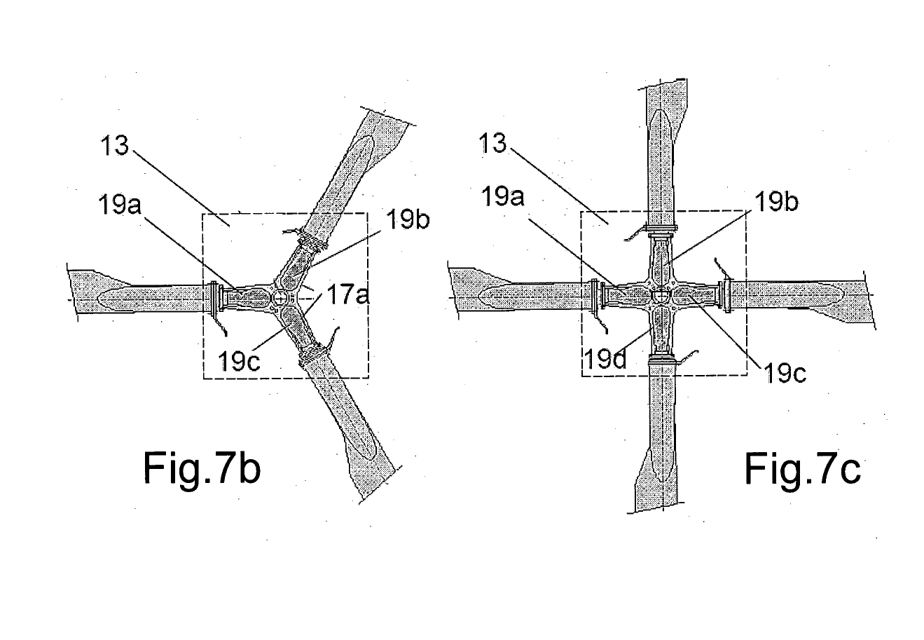

FIG. 7a shows, in the case of a two-bladed helicopter, a top view of the rotor head 13 fixed on the hollow shaft of the rotor 3 and that supports the oscillating blades 2. The oscillating part 18 of the rotor head comprises the flapping hinge 14 and arms 19a and 19b developing from ramifications of the “V” shaped elastomeric flexible tube of the channel 15 to which are attached the blades 2 of the helicopter.

According to another aspect of the invention, as shown in FIG. 4 in the case of a helicopter having N blades, the horizontal flexible structure 17a has a purpose like that of the oscillating part 18 of FIG. 5: i.e. to permit flapping motion. Therefore, the horizontal flexible structure 17a has a branched structure having N arms developing as FIG. 19a, 19b, 19c, for the three-bladed helicopter of FIGS. 7b, and 19a-19b-19c-19d for the four-bladed helicopter of FIG. 7c.

Advantageously according to the invention, this particular configuration of the elastic hollow head 13 and of the flexible elastomeric channel 15 allows to follow the relative movements between the shaft of the rotor 3 and the blades 2 and to create a path for the compressed air towards the nozzles 4 of the blades 2. The connection of the conduit 9 of the hollow shaft of the rotor 3 with the elastomeric channel 15 and with the blades 2 is such as to make the coupling between these elements sealed.

Advantageously according to the invention, the system 20 can be realized inside helicopters with two-bladed rotors or rotors having more than two blades. In this case, the channel 15 is made inside a hollow elastomer block of reinforced material with a special weave of wires of strong materials (as example: glass, or carbon or kevlar or boron) and their combination to achieve the desired elastic properties, forming a plurality of elastic conduits, one for each blade, which lead the compressed air to the ends of each blade.

In operation, the motor 5 acts on the release element 6, which, by means of the gearbox 7, activates the compressor 8. The latter feeds compressed air inside the conduit 9 of the rotating shaft of the rotor 3.

Advantageously according to the invention, the generated compressed air passes through the flexible elastomeric channel 15 and the elastic hollow head 13 of the rotor and is distributed inside the blades 2 arriving at the nozzles 4, by means of an elastic deformation of the elastomeric channel 15 and, respectively, of the oscillating part 18 in the case of two-bladed helicopter, and of the flexible structure 17a, in the case of helicopter having more than two blades.

According to another aspect of the invention, the helicopter 1 is devoid of secondary rotor.

Therefore, the system for operating the helicopter blades with compressed air according to the invention allows to eliminate the external stationary pipes used to convey the fluid mass of gas to the blades of the aircraft, thanks to the particular shape of the hollow oscillating head of the rotor and of the elastomeric flexible channel.

Another advantage of the system for operating the helicopter blades with compressed air according to the invention consists in the payload gain due to the reduction of the total weight of the aircraft, having eliminated all the drive mechanisms and the secondary rotor itself.

Additionally, the system for operating the helicopter blades with compressed air according to the invention allows to obtain greater safety, thanks to the elimination of the risk of breakage of the mechanical transmission system of the motion to the secondary rotor.

Finally, the system for operating the helicopter blades with compressed air according to the invention allows to obtain a yield equaled to that of a classical system of mechanical drive of the main rotor and of the secondary rotor.

Finally it is clear that the system for operating the helicopter blades with compressed air described and illustrated here can be modified and varied without departing from the protective scope of the present invention, as defined in the appended claims.

1. A system for operating hollow blades of a helicopter with compressed air, comprising:
at least a first machine comprising an engine and generate mechanical power to lift the helicopter;
at least a second machine comprising a compressor and configured to generate the compressed air for operating the hollow blades;
a power transmission configured to couple the first machine with the second machine; and
a rotor configured to couple the second machine with the blades, the rotor including a hollow shaft and an oscillating hollow head supporting the blades, the hollow shaft of the rotor internally comprising a conduit connecting the hollow shaft of the rotor to the oscillating hollow head;
wherein the oscillating hollow head is an elastic head and comprises a flexible and deformable elastomeric channel connecting the conduit with the blades, having a shape that includes at least one “V” and having a number of branches equal to the number of the blades and able to guide the compressed air towards nozzles of the blades.

2. The system according to claim 1, further comprising a support structure fixed to the rotor, supporting the hollow head, and connecting the rotor to the blades.

3. The system according to claim 2, wherein the support structure is made of a material comprised in the group constituted by:
metals; and
composites.

4. The system according to claim 2, comprising a flapping hinge, wherein the elastic head comprises an oscillating part supported by the support structure and oscillating around the flapping hinge.

5. The system according to claim 2, wherein the elastic head comprises a horizontal flexible structure supported by the support structure.

6. The system according to claim 4, wherein the oscillating part comprises the flapping hinge and arms extending on the branches of the elastomeric channel to which the blades are connected.

7. The system according to claim 5, wherein the horizontal flexible structure present a branched structure comprising arms extending on the branches of the elastomeric channel.

8. The system according to claim 1, wherein the elastomeric channel is made inside a hollow elastomer block of reinforced material with a weaving of threads of materials comprised in the group constituted by:
steel;
glass;
carbon;
Kevlar;
boron; and
combination thereof.

9. The system according to claim 1, comprising a path for the compressed air that comprises a first portion inside the conduit, a second portion inside the elastomeric channel, and branches internal to conduits of the blades.

10. The system according to claim 1, wherein the power transmission includes:
at least a release element able to allow free rotation of the rotor and activatable by the engine, and
at least one gearbox at an output of the at least one release element configured to activate the compressor.

11. The system according to claim 10, wherein the release element is a clutch.

12. A helicopter comprising:
hollow helicopter blades; and
a system configured to operate the helicopter blades with compressed air, the system including:
at least a first machine comprising an engine and generate mechanical power to lift the helicopter;
at least a second machine comprising a compressor and configured to generate the compressed air for operating the hollow blades:
a power transmission configured to couple the first machine with the second machine; and
a rotor configured to couple the second machine with the blades, the rotor including a hollow shaft and an oscillating hollow head supporting the blades, the hollow shaft of the rotor internally comprising a conduit connecting the hollow shaft of the rotor to the oscillating hollow head;
wherein the oscillating hollow head is an elastic head and comprises a flexible and deformable elastomeric channel connecting the conduit with the blades, having a shape that includes at least one “V” and having a number of branches equal to the number of the blades and able to guide the compressed air towards nozzles of the blades.

13. The helicopter according to claim 12, wherein the rotor is the only rotor of the helicopter.

14. The helicopter according to claim 12, wherein the helicopter blades include more than two blades.
